(19) United States
(12) Patent Application Publication
(10) Pub. No.: US 2002/0139153 A1
(43) Pub. Date: Oct. 3, 2002

(54) Lock with a support helping to extend locking range

(76) Inventor: Cheng-Tao Tsai, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/824,030

(22) Filed: Apr. 3, 2001

(51) Int. Cl. E05B 37/02; E05B 71/00

(52) U.S. Cl. 70/18; 70/30; 70/233

(57) ABSTRACT

A lock with a support helping to extend the locking range includes a steel rope and a separate female lock body. The steel rope is connected to a male locking rod and a ring from two ends. The support has two plates connected to each other, and has a round hole on each of the plates. The male locking rod is passed through the ring for the steel rope to form a loop around a first object, and then the steel rope is passed through other objects to be locked. The male locking rod is passed through one of the round holes, and the steel rope is passed around the last one of the objects. Finally, the male rod is passed through the other round hole, and connects a female locking member, which is wider than the round holes, to lock the objects together. The locking range is longer than half of the length of the steel rope because the steel rope doesn't have to form loops through the intermediate objects.

### BACKGROUND OF THE INVENTION

The present invention relates to a lock, and particularly to a steel rope lock with a support which can hold the lock in position when the lock is not used, and can help the lock to extend the locking range when the object to be locked is relatively big.

Referring to FIG. 7, a conventional steel rope lock includes a steel rope 10, a male locking rod 30 connected to one end of the steel rope 10, and a female locking body 20 connected to the other end of the steel rope 10. The female locking body 20 can be a combination lock which can be opened by turning the rings 201 to a combination of unlocking position.

The lock has a support 40 including a securing part 401, a curved support plate 402, and a locating ring 403 connected to one end of the curved support plate 402. The support 40 is secured to the seat tube 41 of the bicycle from the securing part 401; because steel rope locks are usually used in locking bicycles, we use a bicycle as the example.

When the steel rope lock is not used, the male locking rod 30 is passed through the locating ring 403 to connect the female locking body 20 supported by the curved support plate 402; the steel rope 10 is arranged to form several loops in order not to take too much space.

When the steel rope lock is used to lock the- bicycle, the lock is removed from the support 40, and passed over a stationary pole, and the wheel rim of the bicycle with the male locking rod 30 being combined with the female locking body 20.

However, the steel rope lock is found to have a disadvantage that it can not be used in case the distance from the wheel rim to the stationary pole is longer than one half of the length of the steel rope 10 because the steel rope 10 has to form a loop in locking. And, the support 40 can only support the lock, and can't provide other function for the lock.

### SUMMARY OF THE INVENTION

Therefore, it is a main object of the present invention to provide a steel rope lock with a support such that the lock can extend the locking range with the help of the support.

The steel rope lock has a steel rope connected to a male locking rod from one end, and connected to a ring from other end.

The support has an elongated plate, and a side plate sticking out from an upper portion of one side of the elongated plate. The elongated plate and the side plate each has a round hole and a locking hole in order for the lock to be held on the support with the male locking rod being passed through the locking hole of the side plate to connect a separate female locking body of the lock when the support is secured to an object to be locked from the elongated plate.

The lock can lock several objects, e.g. bicycles together with the male locking rod being passed through the ring for the ring to form a loop on the wheel rim of the first bicycle, and with the steel rope being passed through wheels of other bicycles; the male locking rod being passed through the round hole of the side plate before the steel rope is passed around the wheel of the last bicycle, and being passed through the round hole of the elongated plate to connect the female locking body after the steel rope is passed round the wheel of the last bicycle.

Because the female locking body is wider than the round hole, same won't fall off the support after connecting male locking rod. It is obvious that the locking range is longer than half of the length of the steel rope.

### BRIEF DESCRIPTION OF THE DRAWINGS

This invention will be better understood by referring to the accompanying drawings, wherein:

FIG. 1 is an exploded perspective view of a lock with a support helping to extend locking range according to the first embodiment of the present invention.

FIG. 2 is a perspective view of the lock and the support in FIG. 1 with the support being secured to a bicycle seat tube.

FIG. 3 is a perspective view of a lock and the support of the second embodiment of the present invention.

FIG. 4 is a view showing the lock with the support being used to lock a bicycle according to the present invention.

FIG. 5 is a view showing the lock and the support being used to lock several bicycles together according to the present invention.

FIG. 6 is an exploded perspective view of a lock with a support helping to extend locking range according to the third embodiment of the present invention.

FIG. 7 is a perspective view of the conventional lock with a support in the Background.

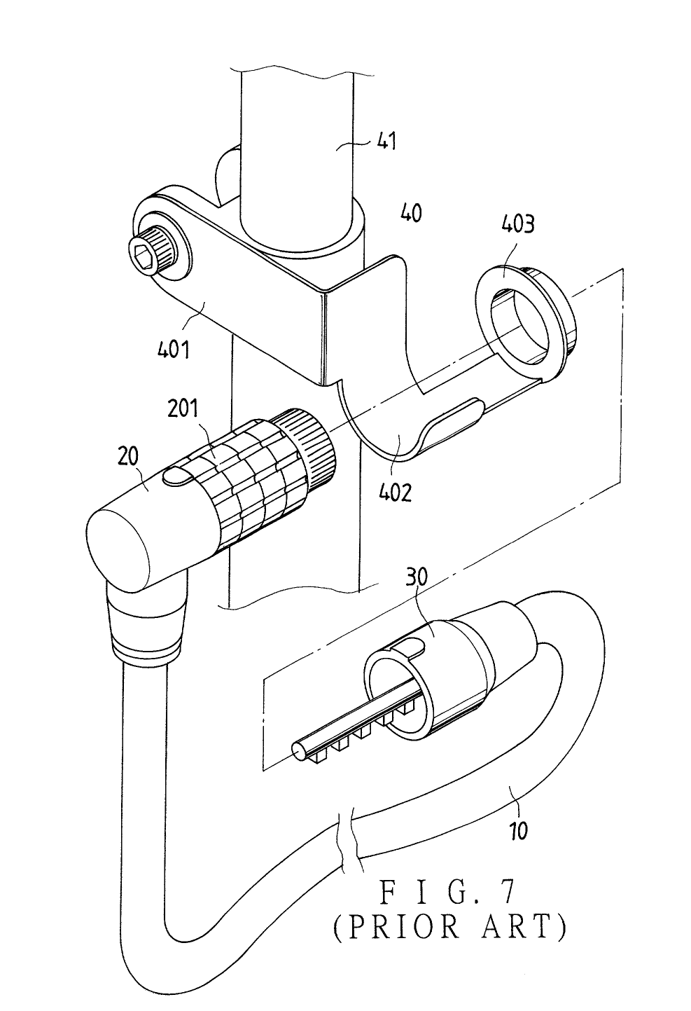

### DETAILED DESCRIPTION OF THE PREFERRED EMBODIMENTS

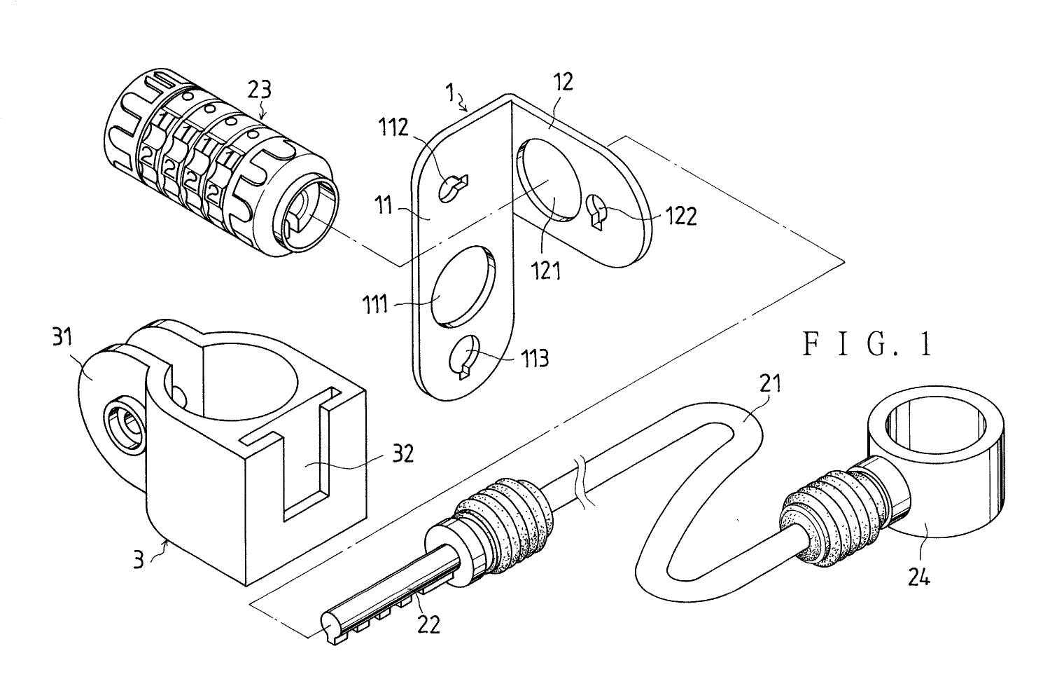

Referring to FIG. 1, a lock with a support helping to extend locking range according to the first embodiment of the present invention includes a male locking rod 22, a steel rope 21, a ring 24, a female locking body 23, a support member 1 and a securing member 3.

The female locking body 23 is a kind of combination lock with a locking channel to connect the male locking rod 22. The steel rope 21 is connected to the male locking rod 22 from one end, and connected to the ring 24 from the other end.

The support member 1 has an elongated plate 11 and a side plate sticking out from one side of an upper portion of the elongated plate 11; the side plate 12 is preferably perpendicular to the elongated plate 11.

The elongated plate 11 has a lock hole 112, a round hole 111 and a securing hole 113. The side plate 12 has a round hole 121 and a lock hole 122. The lock holes 112 and 122 are provided for the male locking rod 22 to pass through to connect the female locking body 23. The round holes 111 and 121 are at least smaller than the outer circumference of the female locking body 23. And, the ring 24 is found such that the male locking rod 22 can pass therethrough.

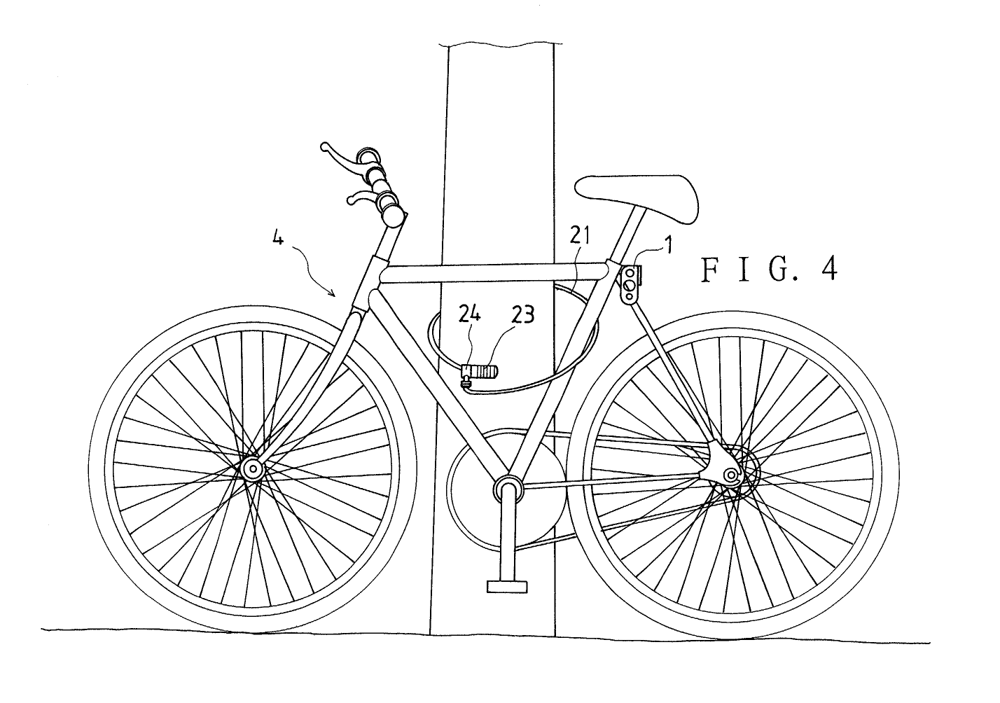

In using the lock to lock an object, e.g., a bicycle, referring to FIG. 4, the steel rope 21 is passed round a stationary hole and the seat tube of the bicycle with the male locking rod 22 first passed through the ring 24 and then connected to the female locking body 23. Thus, the steel rope lock forms a loop to lock the bicycle to the pole. The steel rope 21 can also be passed around the wheel rim or other parts of the bicycle instead.

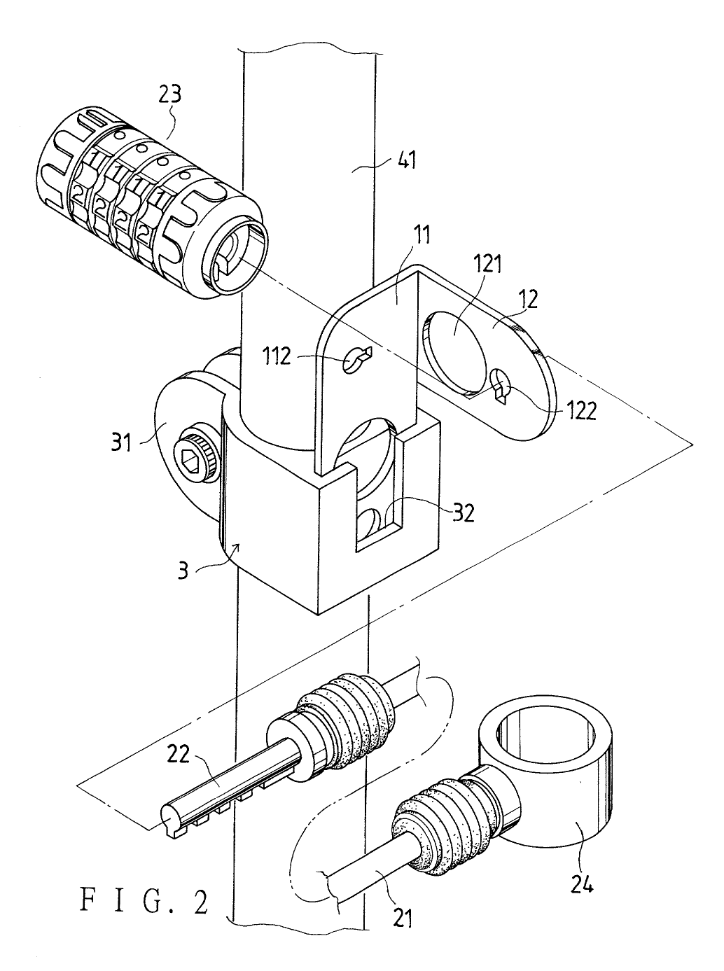

When the lock is not used, the same can be held on the support member 1. Referring to FIGS. 1 and 2, the securing member 3 is secured to one of the support tubes of the bicycle from the connecting part 31, and the support member 1 is connected to the securing member 3 with the lower end portion of the support member 1 inserted into the securing trench 32 of the securing member 3. Thus, the lock can be held by means of the support member 1 with the male locking rod 22 being first passed through the ring 24 and the lock hole 122 of the support member 1, and then connected to the female locking body 23; the steel rope 21 can be arranged to form several loops in order not to take too much space.

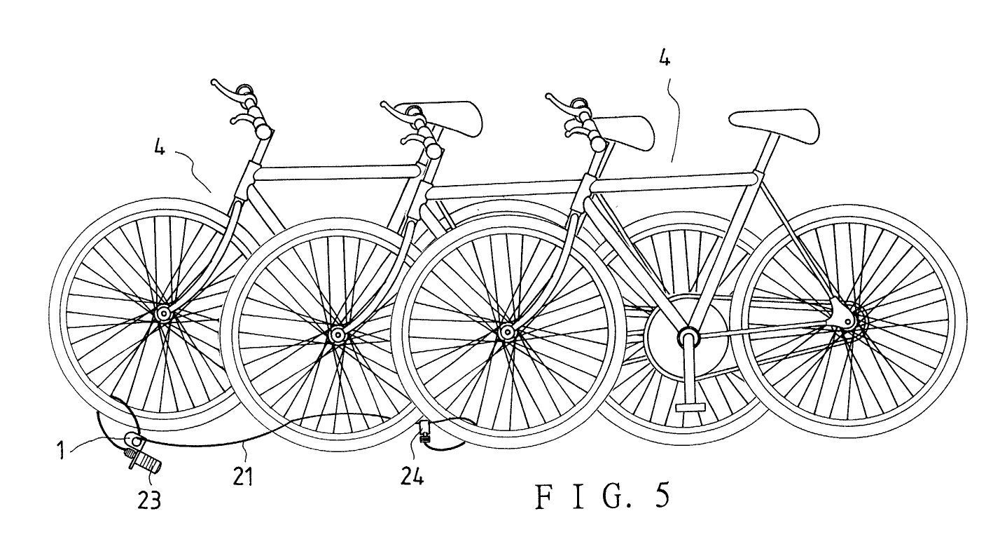

Referring to FIG. 5, when there are many bicycles to be locked together with a steel rope lock of the kind, and the bicycles are not disposed side by side, the steel rope 21 is first passed around the wheel rim of the first bicycle with the male locking rod 22 being passed through the ring 24. Thus, the steel rope 21 is wound around the rims of the second and the third bicycles etc. and the male locking rod 22 is passed through the round hole 121 of the side plate 12 of the support member 1. Finally, the steel rope 21 is passed around the rim of the last one of the bicycles, and the male rod 22 is passed through the round hole 111 of the elongated plate 11, and connected to the female locking body 23. Because the female body 23 is wider than the round hole 111, the lock forms a loop around the rim of the last bicycle to lock same. Thus, the locking range is extended because the lock has a locking distance longer than twice the length of the steel rope 21.

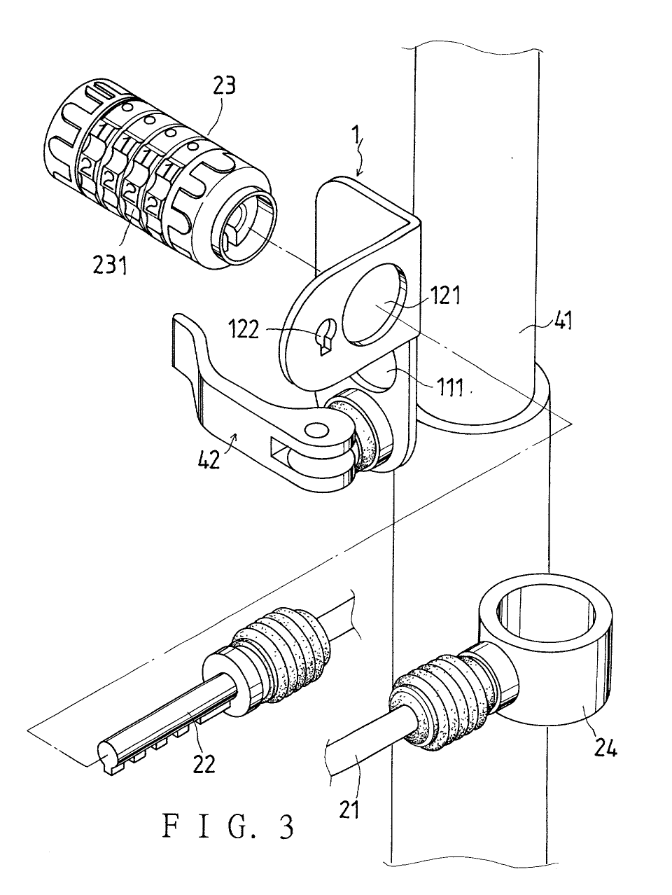

In a second embodiment of the present invention, referring to FIG. 3, a fastener 42 is provided; the fastener 42 can be passed through the securing hole 113 of the support member from a connecting part, and has a lever such that the support member 1 together with the fastener 42 can be attached to, and removed from, the bicycle by means of moving the lever.

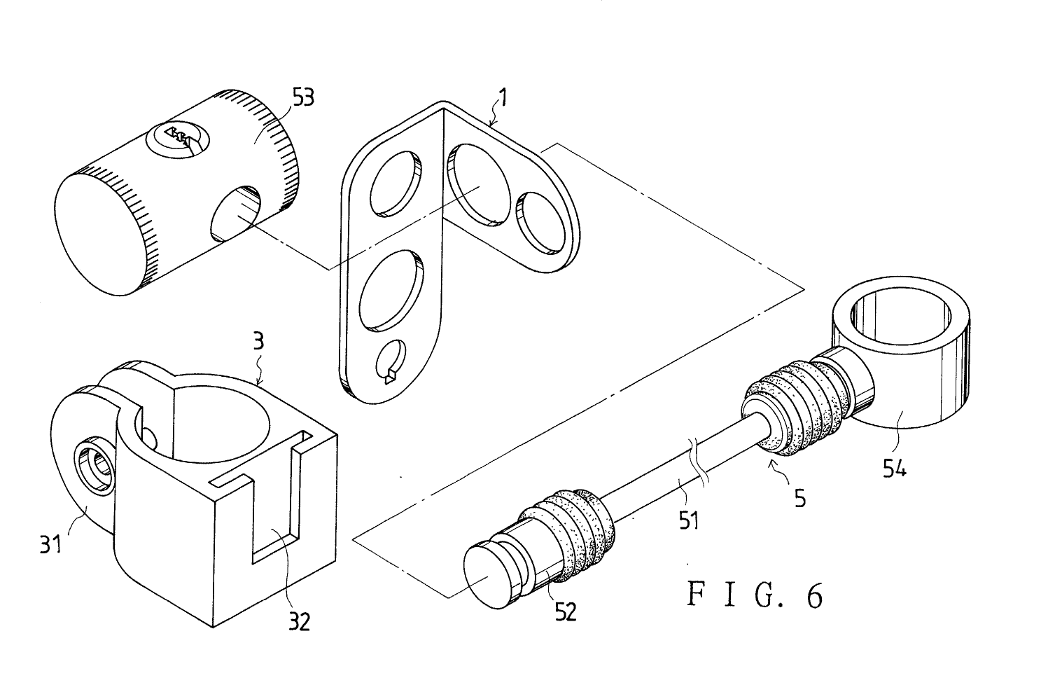

In a third embodiment of the present invention, referring to FIG. 6, the lock 5 has a steel rope 51, a locking rod 52, a ring 54 and a locking main body 53. The steel rope 51 is connected to the locking rod 52 from one end, and the ring 54 from the other end. The locking main body 53 has a locking channel to connect the locking rod 52, and can be unlocked for permitting the locking rod 52 to be disconnected by means of a key (not shown). The way of locking of the lock in the third embodiment is the same as that in the first and the second one so it is not detailed again.

From the above description, the lock with a support member helping to extend the locking range of the present invention can be known to have desirable features as follows:

1. The lock can be easily held on the support member when not in use.

2. The lock doesn't need to form a big loop, which is as at most long as half of the length of the steel rope, to lock an object with the help of the support member.

3. The lock and the support can be secured to a bicycle, etc. even more easily by means of the fastener.

What is claimed is:

1. A lock with a support helping to extend locking range, comprising a lock member, said lock member having a steel rope connected to a male locking rod from a first end, and connected to a ring from a second end;
a support member, said support member having an elongated plate, and a side plate sticking out from an upper portion of one side of said elongated plate;
said elongated plate and said side plate each having a round hole and a locking hole thereon for permitting said lock member to be held on said support member with said male locking rod being passed through said locking hole of said side plate to connect a separate female locking body of said locking member when said support member is secured to an object to be locked from said elongated plate;
said female locking body being wider than said round holes;
said lock member being capable of locking a plurality of objects with said male locking rod being passed through said ring for said steel rope to form a loop on a first one of said objects, and with said steel rope being passed through others of said objects;
said male locking rod being passed through said round hole of said side plate before said steel rope is passed around a last one of said objects;
and said male locking rod being passed through said round hole of said elongated plate to connect said female locking body after said steel rope is passed round said last object.

2. The lock with a support helping to extend locking range as claimed in claim 1, wherein said female locking body is a combination lock.

3. The lock with a support helping to extend locking range as claimed in claim 1, wherein said female locking body is a kind of lock which is locked and unlocked by means of a key.

4. The lock with a support helping to extend locking range as claimed in claim 1, wherein said support member has a securing member fixed on an object to be locked;
said elongated plate being separably inserted into a trench of said securing member to hold said lock when said lock is not used.

5. The lock with a support helping to extend locking range as claimed in claim 1, wherein said support member has a fastener, which is removably connected to an object to be locked.
